(19) United States
(12) Patent Application Publication
(10) Pub. No.: US 2019/0302322 A1
(43) Pub. Date: Oct. 3, 2019

(54) FRESNEL LENS WITH BETTER REFLECTION AREA AND REFRACTION AREA

(71) Applicant: CONCRAFT HOLDING CO., LTD., New Taipei City (TW)

(72) Inventors: Feng-Cheng CHUNG, New Taipei City (TW); Jie-Ru CHEN, New Taipei City (TW)

(21) Appl. No.: 16/031,314

(22) Filed: Jul. 10, 2018

(30) Foreign Application Priority Data
Apr. 3, 2018 (TW) 107111715

(51) Int. Cl. G02B 3/08

(52) U.S. Cl. CPC G02B 3/08

(57) ABSTRACT

The present invention discloses a Fresnel lens with better reflection area and refraction area. The Fresnel lens includes a converging surface and an incidence surface opposite to the converging surface. The incidence surface is provided with an optically effective refractive region and an optically reflective region annularly surrounding the optically effective refractive region. The optically reflective region is provided with a first prism annularly disposed outside the optically effective refractive region and a second prism annularly disposed outside the first prism. The first prism and the second prism are arranged concentrically. A first lead angle portion is formed between the first prism and the second prism, and the radius of the first lead angle portion is between 0.01 mm and 0.019 mm to increase the effective working area of the first reflection surface and the second refraction surface.

### BACKGROUND OF THE INVENTION

### a) Field of the Invention

The present invention relates to a Fresnel lens, and more particularly to a Fresnel lens with better reflection area and refraction area.

### b) Description of the Prior Art

A Fresnel lens is characterized in a short focus, high luminous flux and light in weight. In addition, the application of Fresnel lens is very wide; in particular, the Fresnel lenses are largely used on flashlights in existing smartphones to increase the projected angles of light of the flashlights.

The Fresnel lens applied on the flashlight of the existing smartphone is primarily formed by injection molding to a plastic material, and the Fresnel lens includes a converging surface and an incidence surface. The incidence surface is provided with an optically effective refractive region and at least an optically reflective region surrounding the optically effective refractive region. The optically reflective region includes a first prism that is annularly disposed outside the optically effective refractive region and a second prism that is annularly disposed outside the first prism. The first prism and the second prism are arranged concentrically, and the first prism is provided with a first refraction surface in adjacent to the optically effective refractive region and a first reflection surface that is disposed at a first angle relative to the first refraction surface; whereas, the second prism is provided with a second refraction surface that is connected with the first reflection surface and is disposed at a second angle relative to the first reflection surface, as well as a second reflection surface that is disposed at a third angle relative to the second refraction surface, with a first lead angle portion being connected between the first reflection surface and the second refraction surface.

However, the conventional Fresnel lens is formed integrally by heating up a plastic material into liquid that is then injected into a mold, followed by being cooled down in the mold. Therefore, when the first lead angle portion is formed in the plastic material, in addition to that the plastic material will be affected by the contraction in the cooling process, the plastic material will not be completely filled into the mold in the process of injection, due to the bad fluidity of the plastic material itself, thereby resulting in that the radius of the first lead angle portion is too large. It is found from an actual measurement to the conventional Fresnel lens that the radius of the first lead angle portion is roughly between 0.02 mm and 0.025 mm, which in turn limits the effective working area of the first reflection surface and the second refraction surface, thereby affecting the light receiving effect of the Fresnel lens.

Accordingly, how to provide a Fresnel lens to increase the reflection area, the refraction area and the overall light receiving effect is the technical means and the object thereof to be solved by the present invention.

### SUMMARY OF THE INVENTION

The primary object of the present invention is to provide a Fresnel lens, and more particularly to a Fresnel lens with better reflection area and refraction area.

To achieve the abovementioned object, the present invention discloses a Fresnel lens with better reflection area and refraction area. The Fresnel lens comprises a converging surface and an incidence surface opposite to the converging surface. The incidence surface is provided with an optically effective refractive region and an optically reflective region surrounding the optically effective refractive region. The optically reflective region is provided with a first prism that is annularly disposed outside the optically effective refractive region and a second prism that is annularly disposed outside the first prism. The first prism and the second prism are arranged concentrically, and the first prism is provided with a first refraction surface in adjacent to the optically effective refractive region and a first reflection surface that is disposed at a first angle relative to the first refraction surface; whereas, the second prism is provided with a second refraction surface that is connected with the first reflection surface and is disposed at a second angle relative to the first reflection surface, as well as a second reflection surface that is disposed at a third angle relative to the second refraction surface. A first lead angle portion is connected between the first reflection surface and the second refraction surface, and the radius of the first lead angle portion is between 0.01 mm and 0.019 mm to increase the effective working area of the first reflection surface and the second refraction surface.

In an embodiment, the optimal radius of the first lead angle portion is 0.018 mm.

In an embodiment, the Fresnel lens is further made of silica gel.

In an embodiment, the Fresnel lens further includes a positioning portion that is disposed between the converging surface and the incidence surface.

In an embodiment, the positioning portion is further disposed annularly between the converging surface and the incidence surface.

In an embodiment, a second lead angle is further disposed between the first refraction surface and the first reflection surface, opposite to the first lead angle portion. In addition, the radius of the second lead angle portion is between 0.01 mm and 0.019 mm to increase the effective working area of the first refraction surface and the first reflection surface.

In an embodiment, the optimal radius of the second lead angle portion is 0.018 mm.

In an embodiment, a third lead angle portion is further disposed between the second reflection surface and the second refraction surface, opposite to the first lead angle portion. In addition, the radius of the third lead angle portion is between 0.01 mm and 0.019 mm to increase the effective working area of the second reflection surface and the second refraction surface.

In an embodiment, the optimal radius of the third lead angle portion is 0.018 mm.

The present invention provides a Fresnel lens with better reflection area and refraction area and is provided with following advantages in comparison with the prior art.

The Fresnel lens of the present invention is made of silica gel. Therefore, the radius of the first lead angle portion, the second lead angle portion and the third lead angle portion can be reduced effectively, which increases the effective working area of the first refraction surface, the first reflection surface, the second refraction surface and the second reflection surface, thereby providing a more effective light receiving effect to the optically reflective region.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a cutaway view of a Fresnel lens, according to the present invention.

FIG. 2 shows a local blowup view of FIG. 1.

FIG. 3 shows a cutaway view of the present invention being applied on a flashlight.

FIG. 4 shows a schematic view of an optically effective area of the present invention and the prior art.

### DETAILED DESCRIPTION OF THE PREFERRED EMBODIMENTS

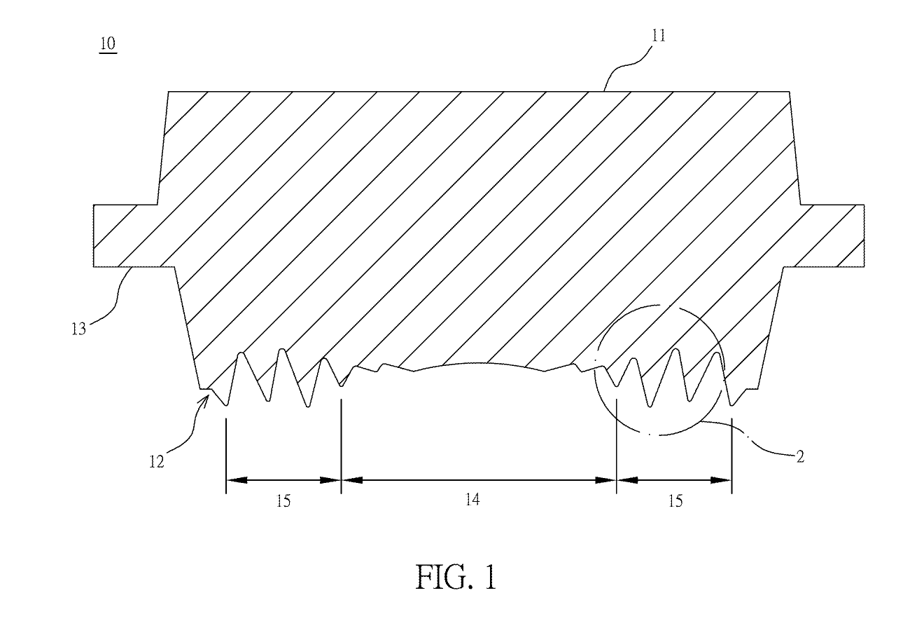

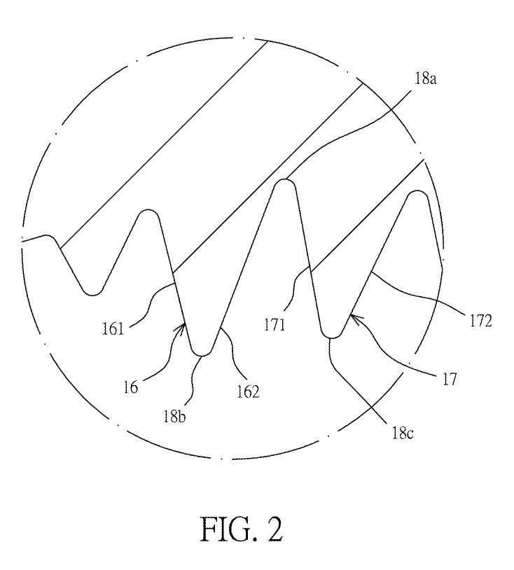

Referring to FIG. 1 and FIG. 2, the present invention discloses a Fresnel lens with better reflection area and refraction area. In the present embodiment, a Fresnel lens 10 is formed integrally by injecting silica gel into a mold (not shown in the drawings). As silica gel itself is provided with better fluidity as compared with the abovementioned plastic material, when silica gel is injected into the mold through heating, silica gel can be filled completely into the mold, forming the Fresnel lens in the present invention after silica gel is cooled down in the mold.

The Fresnel lens 10 comprises a converging surface 11, an incidence surface 12 opposite to the converging surface 11, and a positioning portion 13 that is annularly disposed between the converging surface 11 and the incidence surface 12. The incidence surface 12 is provided with an optically effective refractive region 14 and an optically reflective region 15 annularly surrounding the optically effective refractive region 14. The optically reflective region 15 is provided with a first prism 16 that is annularly disposed outside the optically effective refractive region 14 and a second prism 17 that is annularly disposed outside the first prism 16. The first prism 16 and the second prism 17 are arranged concentrically. The first prism 16 is provided with a first refraction surface 161 in adjacent to the optically effective refractive region 14 and a first reflection surface 162 that is disposed at a first angle relative to the first refraction surface 161. The second prism 17 is provided with a second refraction surface 171 that is connected with the first reflection surface 162 and is disposed at a second angle relative to the first reflection surface 162, as well as a second reflection surface 172 that is disposed at a third angle relative to the second refraction surface 171.

A first lead angle portion 18a is formed between the first reflection surface 162 and the second refraction surface 171, a second lead angle portion 18b is formed between the first refraction surface 161 and the first reflection surface 162, and a third lead angle portion 18c is formed between the second refraction surface 171 and the second reflection surface 172. The second lead angle portion 18b is separated from the third lead angle portion 18c, and the first lead angle portion 18a is opposite to the second lead angle portion 18b and the third angle portion 18c. For the Fresnel lens 10 in the present invention, as silica gel with better fluidity is injected into the mold, when silica gel is contracted in the mold through cooling, radius between 0.01 mm and 0.019 mm will be formed to the first lead angle portion 18a, the second lead angle portion 18b and the third lead angle portion 18c respectively. In the present embodiment, the optimal radius is 0.018 mm after an actual test.

Accordingly, by reducing the radius of the first lead angle portion 18a, the second lead angle portion 18b and the third lead angle portion 18c, the connection distance among the first lead angle portion 18a, the second lead angle portion 18b and the third lead angle portion 18c will be increased, which further increases the effective working area of the first refraction surface 161, the first reflection surface 162, the second refraction surface 171 and the second reflection surface 172.

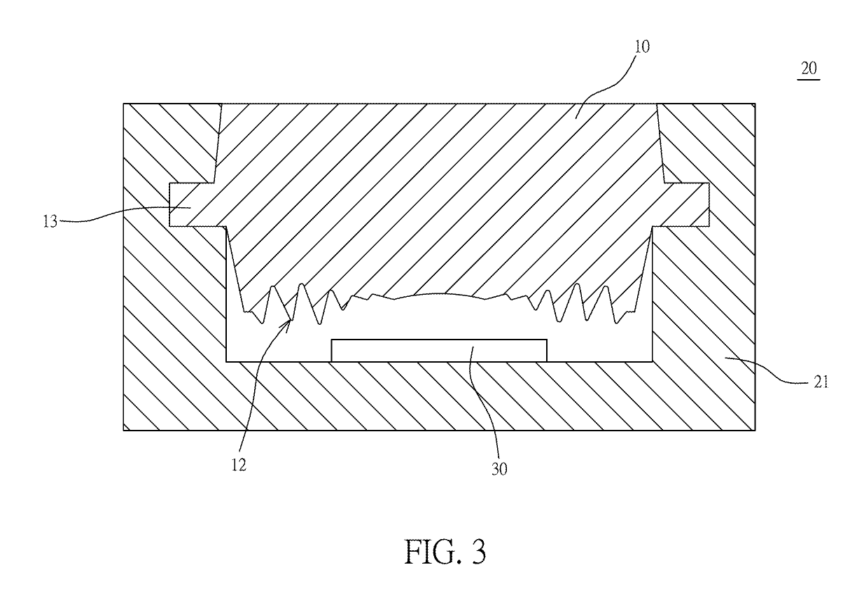

Moreover, as shown in FIGS. 1 to 3, when the Fresnel lens 10 of the present invention is applied on a flashlight 20, the Fresnel lens 10 is fixed on a casing 21 primarily by the annular-shaped positioning portion 13 and is disposed on a light emitting unit 30, so that the incidence surface 12 is opposite to the light emitting unit 30. When the light emitting unit 30 projects a beam of light, the light beam passing through the optically effective refractive region 14 will directly pass through the Fresnel lens 10 and project outward from the converging surface 11. On the other hand, the light beam that passes through the optically reflective region 15 will pass through the first refraction surface 161 and the second refraction surface 171 respectively, projecting onto the first reflection surface 162 and the second reflection surface 172 after being refracted. Finally, the light beam will be projected outward from the converging surface 11 by reflection through the first reflection surface 162 and the second reflection surface 172.

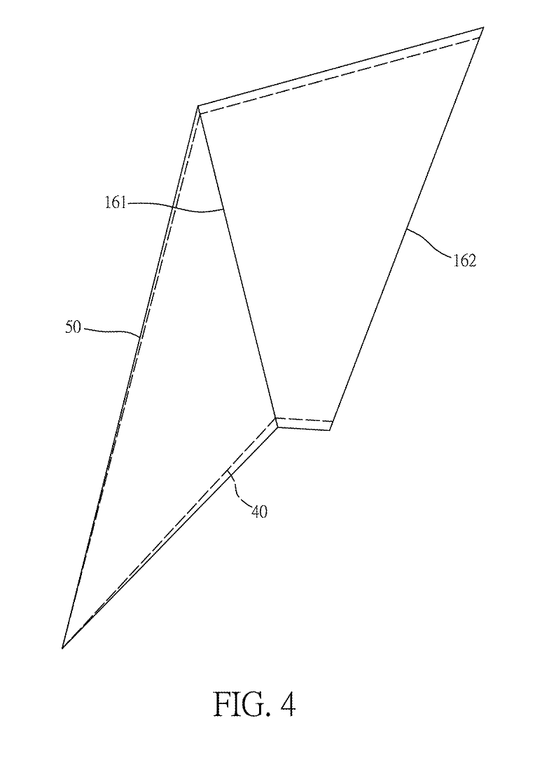

Referring to FIG. 1, FIG. 2 and FIG. 4, it shows an optically effective region formed by a same light source passing through the first refraction surface 161 and the first reflection surface 162 in the prior art and the present invention. A dashed-line part 40 represents the optically effective region formed in the prior art when the light source is projected onto the first reflection surface 162 after passing through the first refraction surface 161. On the other hand, a solid-line part 50 represents the optically effective region formed in the present invention when the light source is projected onto the first reflection surface 162 after passing through the first refraction surface 161.

It can be clearly seen from the drawings that the optically effective region formed in the solid-line part 50 is obviously larger than the optically effective region formed in the dashed-line part 40. In other words, in the present invention, by reducing the radius of the first lead angle portion 18a, the second lead angle portion 18b and the third lead angle portion 18c, the area formed after the light beam passes through the first refraction surface 161 and the second refraction surface 171 can be increased effectively, and the area formed after the light beam passes through the first reflection surface 162 and the second reflection surface 172 can be increased too. Therefore, by the Fresnel lens 10, more light beams projected from the light emitting unit 30 are able to pass through, allowing the optically reflective region 15 to achieve a more effective light receiving effect, which in turn increases the range of irradiation after the light beams are projected outward from the converging surface 11, so as to improve the operational efficiency of the flashlight.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A Fresnel lens with better reflection area and refraction area, comprising a converging surface and an incidence surface opposite to the converging surface, with that the incidence surface is provided with an optically effective refractive region and an optically reflective region annularly surrounding the optically effective refractive region, the optically reflective region is provided with a first prism annularly disposed outside the optically effective refractive region and a second prism annularly disposed outside the first prism, the first prism and the second prism are arranged concentrically, the first prism is provided with a first refraction surface in adjacent to the optically effective refractive region and a first reflection surface disposed at a first angle relative to the first refraction surface, and the second prism is provided with a second refraction surface connected with the first reflection surface and disposed at a second angle relative to the first reflection surface, as well as a second reflection surface disposed at a third angle relative to the second refraction surface, wherein a first lead angle portion is connected between the first reflection surface and the second refraction surface, and the radius of the first lead angle portion is between 0.01 mm and 0.019 mm to increase the effective working area of the first reflection surface and the second refraction surface.

2. The Fresnel lens with better reflection area and refraction area, according to claim 1, wherein the optimal radius of the first lead angle portion is 0.018 mm.

3. The Fresnel lens with better reflection area and refraction area, according to claim 1, wherein the Fresnel lens is further made of silica gel.

4. The Fresnel lens with better reflection area and refraction area, according to claim 1, wherein the Fresnel lens further includes a positioning portion which is disposed between the converging surface and the incidence surface.

5. The Fresnel lens with better reflection area and refraction area, according to claim 4, wherein the positioning portion is further disposed annularly between the converging surface and the incidence surface.

6. The Fresnel lens with better reflection area and refraction area, according to claim 1, wherein a second lead angle portion is further disposed between the first refraction surface and the first reflection surface and opposite to the first lead angle portion, with that the radius of the second lead angle portion is between 0.01 mm and 0.019 mm to increase the effective working area of the first refraction surface and the first reflection surface.

7. The Fresnel lens with better reflection area and refraction area, according to claim 6, wherein the optimal radius of the second lead angle portion is 0.018 mm.

8. The Fresnel lens with better reflection area and refraction area, according to claim 1, wherein a third lead angle portion is further disposed between the second reflection surface and the second refraction surface and opposite to the first lead angle portion, with that the radius of the third lead angle portion is between 0.01 mm and 0.019 mm to increase the effective working area of the second reflection surface and the second refraction surface.

9. The Fresnel lens with better reflection area and refraction area, according to claim 8, wherein the optimal radius of the third lead angle portion is 0.018 mm.
